(19) United States
(12) Patent Application Publication
(10) Pub. No.: US 2022/0383197 A1
(43) Pub. Date: Dec. 1, 2022

(54) FEDERATED LEARNING USING SECURE CENTERS OF CLIENT DEVICE EMBEDDINGS

(71) Applicant: QUALCOMM Incorporated, San Diego, CA (US)

(72) Inventors: Hyunsin PARK, Gwangmyeong (KR); Hossein HOSSEINI, San Diego, CA (US); Sungrack YUN, Seongnam (KR); Kyu Woong HWANG, Daejeon (KR)

(21) Appl. No.: 17/828,613

(22) Filed: May 31, 2022

Related U.S. Application Data
(60) Provisional application No. 63/195,517, filed on Jun. 1, 2021.

(51) Int. Cl. G06N 20/00; G06F 21/62

(52) U.S. Cl. CPC G06N 20/00; G06F 21/62

(57) ABSTRACT

Certain aspects of the present disclosure provide techniques for training a machine learning model. The method generally includes receiving, at a local device from a server, information defining a global version of a machine learning model. A local version of the machine learning model and a local center associated with the local version of the machine learning model are generated based on embeddings generated from local data at a client device and the global version of the machine learning model. A secure center different from the local center is generated based, at least in part, on information about secure centers shared by a plurality of other devices participating in a federated learning scheme. Information about the local version of the machine learning model and information about the secure center is transmitted by the local device to the server.

### CROSS-REFERENCE TO RELATED APPLICATIONS

This application claims benefit of and priority to U.S. Provisional Patent Application Ser. No. 63/195,517, entitled “Federated Learning Using Secure Centers of Client Device Embeddings,” filed Jun. 1, 2021, and assigned to the assignee hereof, the contents of which are hereby incorporated by reference in its entirety.

### INTRODUCTION

Aspects of the present disclosure relate to machine learning.

Federated learning generally refers to various techniques that allow for training a machine learning model to be distributed across a plurality of client devices, which beneficially allows for a machine learning model to be trained using a wide variety of data. For example, using federated learning to train machine learning models for facial recognition may allow for these machine learning models to train from a wide range of data sets including different sets of facial features, different amounts of contrast between foreground data of interest (e.g., a person's face) and background data, and so on.

In some examples, federated learning may be used to learn embeddings, or mappings between an input and a representation of the input, across a plurality of client devices. These embeddings are generally based on various learned parameters that result in a mapping from an input to a representation of the input. However, sharing embeddings of a model may not be appropriate, as the embeddings of a model may contain client-specific information. For example, the embeddings may expose data from which sensitive data used in the training process can be reconstructed. Thus, for machine learning models trained for security-sensitive applications or privacy-sensitive applications, such as biometric authentication or medical applications, sharing the embeddings of a model may expose data that can be used to break biometric authentication applications or to cause a loss of privacy in other sensitive data.

Accordingly, what is needed are improved techniques for training machine learning models using federated learning techniques.

### BRIEF SUMMARY

Certain aspects provide a method for training a machine learning model. The method generally includes receiving, at a local device from a server, information defining a global version of a machine learning model. A local version of the machine learning model and a local center associated with the local version of the machine learning model are generated based on embeddings generated from local data at a client device and the global version of the machine learning model. A secure center different from the local center is generated based, at least in part, on information about secure centers shared by a plurality of other devices participating in a federated learning scheme. Information about the local version of the machine learning model and information about the secure center is transmitted by the local device to the server.

Other aspects provide a method for distributing training of a machine learning model across client devices. The method generally includes selecting a set of client devices to use in training a machine learning model. A request to update the machine learning model is transmitted to each respective client device in the selected set of client devices. Updates to the machine learning model and information about a secure center for a respective client device are received from each respective client device in the selected set of client devices. The machine learning model is updated based on the updates and information about the secure center received from each respective client device in the selected set of client devices.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example environment in which machine learning models are trained by a plurality of client devices using federated learning techniques.

FIG. 2 illustrates an example pipeline for training a machine learning model at a client device participating in a federated learning process.

FIG. 3 illustrates an example of minimizing intra-class variation and maximizing inter-class variation in a machine learning model trained using federated learning.

FIG. 4 illustrates example local and secure hyperspheres generated by client devices participating in training a machine learning model using federated learning, according to aspects of the present disclosure.

FIGS. 5A and 5B illustrate examples of a secure center of a hypersphere selected based on a true center of the hypersphere and an angle relative to the true center, according to aspects of the present disclosure.

FIG. 6 illustrates example operations that may be performed by a client device for training a machine learning model, according to aspects of the present disclosure.

FIG. 7 illustrates example operations that may be performed by a server to distribute training of a machine learning model across a plurality of client devices, according to aspects of the present disclosure.

FIG. 8 illustrates an example implementation of a processing system in which a machine learning model can be trained, according to aspects of the present disclosure.

FIG. 9 illustrates an example implementation of a processing system in which training of a machine learning model across client devices can be performed, according to aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for training a machine learning model using federated learning while protecting the privacy of data used to train the machine learning model.

In systems where a machine learning model is trained using federated learning, the machine learning model is generally defined based on model updates (e.g., changes in weights or other model parameters) generated by each of a plurality of participating client devices. Generally, each of these client devices may train a model using data stored locally on the client device. By doing so, the machine learning model may be trained using a wide variety of data, which may reduce the likelihood of the resulting global machine learning model underfitting data (e.g., resulting in a model that neither fits the training data nor generalizes to new data) or overfitting the data (e.g., resulting in a model that fits too closely to the training data such that new data is inaccurately generalized).

Sharing embeddings generated by each of the participating client devices when training the global machine learning model using federated learning, however, may impose various challenges to the security and privacy of data used to train the machine learning model on client devices. Because the embeddings are closely coupled with the data used to generate the embeddings, sharing the embeddings between different client devices or to a server coordinating the training of the machine learning model may expose sensitive data. In exposing sensitive data, sharing the embeddings generated by a client device with other devices in a federated learning environment may thus create security risks (e.g., for biometric data used to train machine learning models deployed in biometric authentication systems) or may expose private data to unauthorized parties.

Aspects of the present disclosure provide techniques for federated learning of machine learning models that improve security and privacy when sharing embedding data generated by client devices used to train a machine learning model compared to conventional methods. In training a machine learning model, a client device can identify a centroid and a radius of a local hypersphere representing the embeddings generated from local data and a current version of a global machine learning model. The identified centroid generally corresponds to a defined center point of the local hypersphere representing the embeddings generated from local data at a specific device using the current version of the machine learning model. However, instead of sharing the identified centroid of the local hypersphere with other devices participating in training the machine learning model or a server coordinating the training of the machine learning model, the client device can generate a larger secure hypersphere containing the local hypersphere. Information about this secure hypersphere, along with information about a local version of the machine learning model, may be shared with a server and/or other client devices that are participating in the training of the machine learning model. By sharing information about a secure hypersphere that encompasses the local hypersphere and other data, aspects of the present disclosure can participate in a federated learning process without exposing information about the underlying data set used to train the machine learning model. Thus, the security and privacy of the data in the underlying data set used to train the machine learning model may be preserved, which may improve the security and privacy of data relative to federated learning approaches in which the centroids of local hyperspheres generated by a machine learning model are shared with other client devices or a server coordinating training of the machine learning model. Further, distances between local centroids and secure centroids of these hyperspheres may be a controllable parameter to influence the accuracy of the machine learning model and the privacy of the data in the underlying data set used to train the machine learning model may be preserved.

### Example Federated Learning Architecture

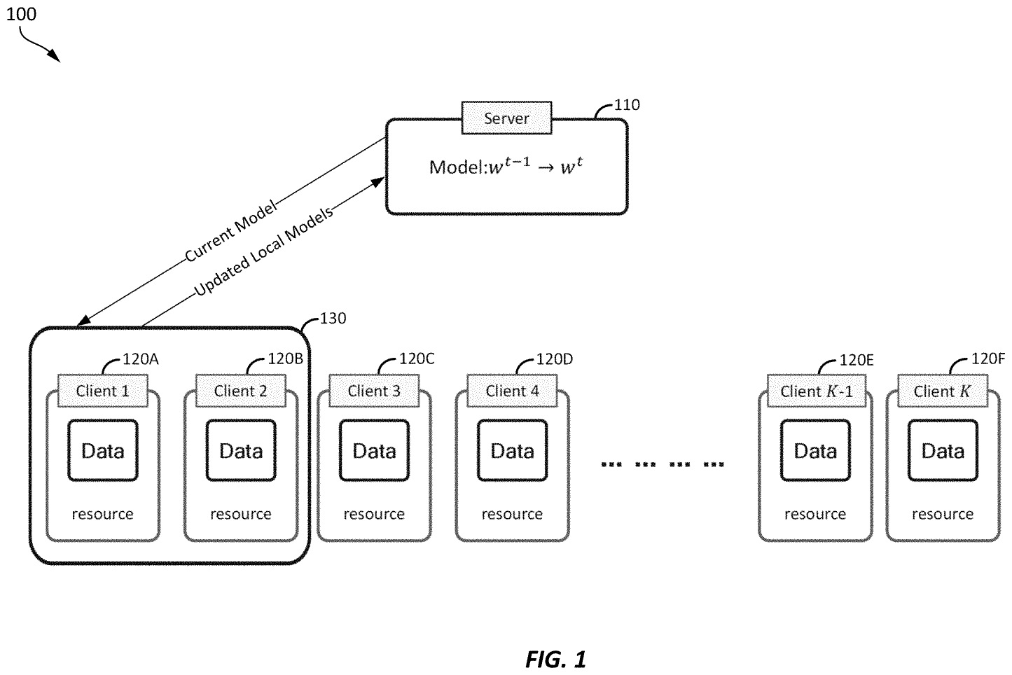

FIG. 1 depicts an example environment 100 in which machine learning models are trained by a plurality of client devices using federated learning techniques. As illustrated, environment 100 includes a server 110 and a plurality of client devices 120.

Server 110 generally maintains a global machine learning model that may be updated by one or more client devices 120. The global machine learning model may be an embedding network defined according to the equation g_{θ}(⋅): χ→ [symbol] ^{d} with input data x∈χ. The embedding network generally takes x as an input and predicts an embedding vector g_{θ}(x). In some examples, the embedding network may be learned based on classification losses or metric learning losses. Classification losses may include, for example, softmax-based cross entropy loss or margin-based losses, among other types of classification losses. Metric learning losses may include, for example, contrastive loss, triplet loss, prototypical loss, or other metric-based losses.

To train (or update) the global machine learning model maintained at server 110, server 110 can select a group 130 of client devices 120 that are to train (or update) the global machine learning model. In some aspects, the group 130 of client devices may include an arbitrary number m of client devices and may be selected based on various characteristics, such as how recently a client device has participated in training (or updating) the global machine learning model, mobility and power characteristics, available computing resources that can be dedicated to training or updating a model, and the like. As illustrated, group 130 includes client devices 120A and 120B; thus, in the example illustrated in FIG. 1, client devices 120A and 120B will participate in training (or updating) the global machine learning model, and client devices 120C, 120D, 120E, and 120F may not participate in training (or updating) the machine learning model. However, in a different round of training or updating of the global machine learning model, server 110 can select any of client devices 120A-120E to train or update the global machine learning model. The members of group 130 may, but need not, change for each round of training or updating of the machine learning model coordinated by server 110.

After server 110 selects the group 130 of client devices, server 110 can invoke a training process at each client device 120 included in the group 130 by providing the current version of the global machine learning model to the client devices 120 included in the group 130 of client devices (e.g., in this example, client devices 120A and 120B). The client devices 120A and 120B in the group 130 may generate an updated local model based on the data stored at each client device and upload the updated local models to server 110 for integration into the global machine learning model.

Server 110 can update the global model using various model aggregation techniques. For example, as illustrated in FIG. 1, the server 110 can update the model based on a running average of the weights associated with local models generated by the client devices 120 over time or based on other statistical measures of the weights associated with the local models generated by the client devices 120 over time (both client devices 120 that previously participated in training or updating the global machine learning model and client devices 120 included in group 130). These running averages or other statistical measures may be based on the weights generated by client devices 120 that previously participated in training or updating the machine learning model as well as the weights generated by the client devices 120 in group 130. In some aspects, various levels of importance may be given to the weights associated with the local models generated by the client devices 120, with weights generated by client devices in group 130 being assigned higher levels of importance than weights previously generated by other client devices. In some aspects, newer local model information (e.g., weights, parameter values, etc.) may replace older local model information in a data set of models over which the global model is generated. After the global model is updated, server 110 can deploy the updated global model to the client devices 120A-120F in environment 100 for use in performing inferences at each of the client devices 120A-120F.

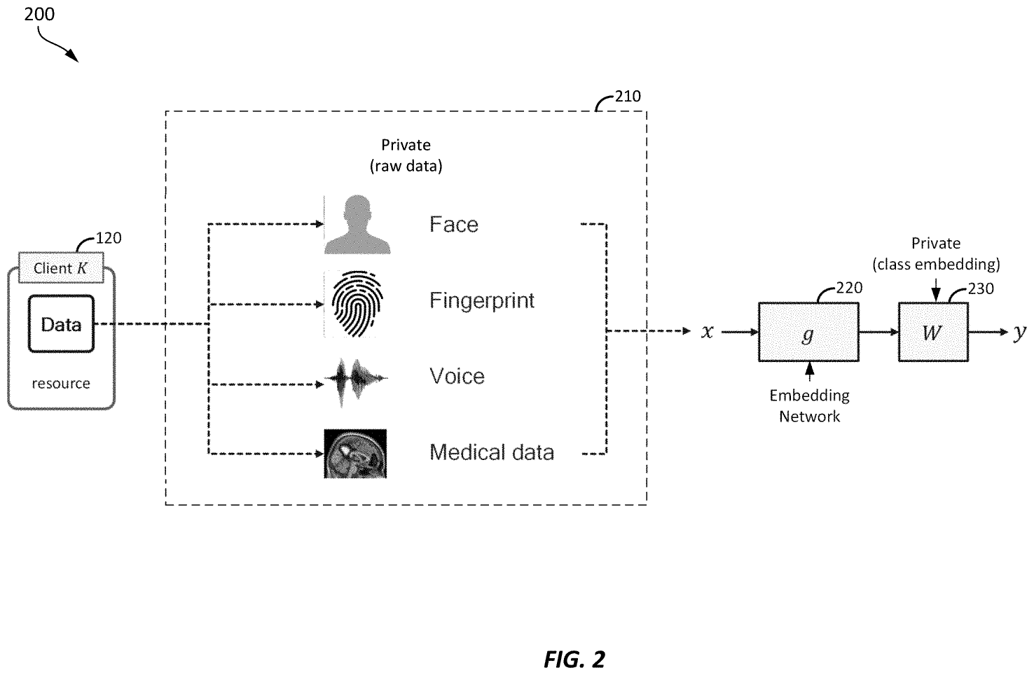

FIG. 2 illustrates an example pipeline 200 for training a machine learning model at a client device participating in a federated learning process. As illustrated, a client device 120 may store various types of private data 210 that can be used to train a machine learning model. This private data may include, for example, facial recognition data (e.g., images, image maps, or the like), fingerprint data, voice data, medical data, and other data that may have security and/or privacy implications if such data were exposed. Because private data 210 should not be exposed, federated learning techniques allow for the machine learning model to be trained by a plurality of client devices without directly committing the private data 210 to external storage devices (e.g., cloud storage) or communicating the private data 210 via communications links between a client device 120 and an external storage device.

In pipeline 200, each item of data in private data 210 may be selected as an input x into an embedding network g 220 parametrized by θ. As discussed, the embedding network g 220 generally takes an input and predicts an instance embedding vector g_{θ}(x) for the input x. The class embedding layer 230 of the machine learning model, designated W, may be a private class embedding for private data 210 input into the pipeline 200 to train the machine learning model at the client device. As discussed, because this last layer includes sensitive data, or at least data from which sensitive data can be extracted, sharing this last layer 230 of the machine learning model may also pose privacy and security concerns.

As discussed, centroids generated from local data at each of a plurality of participating client devices can be used to train a machine learning model using federated learning techniques. To train a robust model, client devices may be made aware of the centroids associated with other client devices so that centroids associated with different data sets are spaced far apart from each other in an n-dimensional space. Generally, by spacing centroids generated by different client devices far apart from each other in an n-dimensional space, the hyperspheres defining the clusters with these centroids may also be spaced far apart so that different classes of data associated with different devices are located in different spaces in the n-dimensional space. Thus, data may not be incorrectly classified due to an overlap between hyperspheres representing different classes of data in the machine learning model.

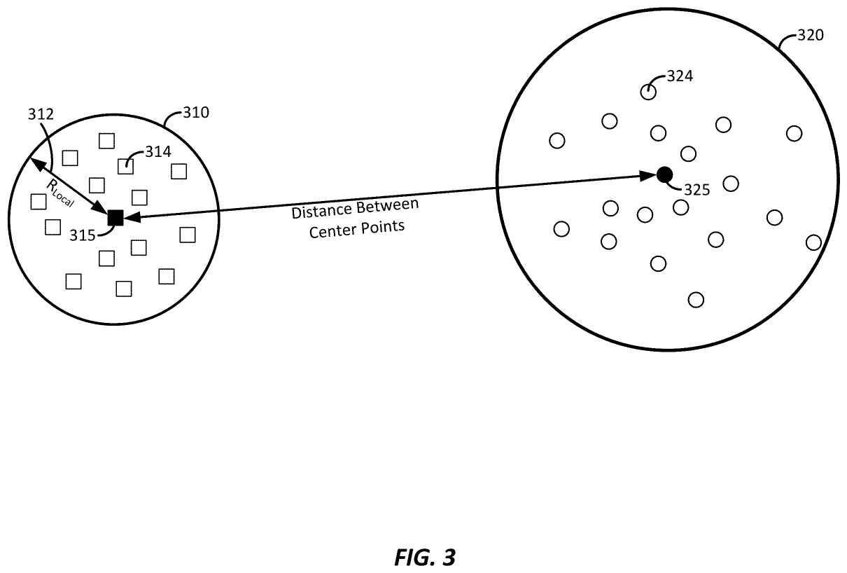

FIG. 3 illustrates an example of a target result of a discriminative learning approach in federated learning in which intra-class variation is minimized and inter-class variation is maximized. In training a machine learning model using a discriminative learning approach, models may be trained to discriminate between different types (or classes) of data, which may be represented by different data sets at different participating client devices.

Generally, for a machine learning model trained at a client device resulting in embedding space 310 for the local data, the goal in training the machine learning model is to minimize intra-class variation. Embedding space 310 may be an area in an n-dimensional space in which class embeddings, such as embedding 314, for each of a plurality of input data items lie and may be defined in terms of a centroid 315 and a radius R_{Local} 312 in the n-dimensional space. Relative to a defined centroid 315 for the embedding space 310, which may be the embedding closest to the center of embedding space 310, the goal of discriminative learning is to minimize the radius (or size) of the embedding space 310. By minimizing the radius of the embedding space 310, predictions for data that is similar to that used to train the machine learning model may have less variance. Classifications may be made more accurate (for classifier machine learning models).

Meanwhile, to train a global machine learning model from models generated from each of a plurality of client devices, the center points associated with local hyperspheres generated by each of the client devices may be defined to maximize inter-class variation between embedding space 310 and another embedding space 320 associated with another one of the client devices. The embedding space 320 generally includes a plurality of embeddings, such as embedding 324, and a centroid 325 associated with the embedding that is closest to the center of embedding space 320. By maximizing the distance between centroid 315 and centroid 325, which may also maximize the distance between the perimeters of embedding spaces 310 and 320, the machine learning model may be trained to make predictions over a larger n-dimensional space, which may allow for different types of data to be accurately classified.

### Example Federated Learning Techniques

Various techniques for federated learning generally attempt to train a machine learning model without sharing sensitive data between different client devices. These techniques, however, may have various performance or privacy considerations, as discussed in further detail below.

In a first example, a neural network-based machine learning model is trained by minimizing the volume of a hypersphere enclosing a network representation of data. The hypersphere generally represents an n-dimensional space in which multi-dimensional input data is mapped. In this example, common factors of variation are extracted, as data points are mapped closely to the center of the hypersphere. To avoid a hypersphere collapse situation with many data points (e.g., centroids associated with data from different client devices) mapped to the center of the hypersphere, the neural network may not include bias terms or a bounded activation function that specifies an upper bound and/or lower bound value for the function. A loss function in this example may be represented according to the equation:

d(g_{θ}(xᵢ),C)²

where d is a distance function, g_{θ}(xᵢ) represents an embedding for an input xᵢ, and C represents the target center obtained from an average of the embeddings generated by each of the client devices. In this example, it may be difficult to extract data from an embedding that maps to a particular centroid; however, this example trades off privacy for accuracy, since a distance between different centroids cannot be significantly maximized.

In a second example, an embedding network-based machine learning model, used for multi-class classification, may be trained using federated learning. The embedding network-based model may be a model defined in terms of a plurality of centroids, with each centroid (corresponding to a center of a local hypersphere defined by embeddings of local data using a machine learning model) representing a different classification of data. In this example, each participating client device has access to its own data, but not to the data from other client devices. The machine learning model may be trained based on contrastive loss according to the equation:

$${d ( {g}_{θ} ( {x}_{i} ) , {w}_{y} )}^{2} + λ {\sum }_{c \neq y} {( max \{ 0 , v - d ( {g}_{θ} ( {x}_{i} ) , {w}_{c} ) \} )}^{2}$$

where d is a distance function, g_{θ}(xᵢ) represents an embedding for an input xᵢ, w_{y} represents a class embedding (or local center) for a hypersphere, λ represents a regularization rate, v represents a margin by which class embeddings are spaced {wᵢ}ᵢ₌₁^{C} represents the class embeddings generated by the client devices. In this case, the loss function may not be optimized at each client device, as client devices do not have access to the embeddings generated by other client devices participating in training the machine learning model. However, the server may optimize the loss function based on the class embeddings generated by each of the participating client devices, according to the equation:

d(g_{θ}(xᵢ),w_{y})²+Σ_{c∈[C′]}Σ_{c′≠c}(max{0,v−d(g_{θ}(xᵢ),w_{c})})²

In this case, while each client device may only have access to embeddings generated from the local data at the client device, each client device may still expose the embeddings to an external system (e.g., server 110 illustrated in FIG. 1).

In a third example, client devices may be configured to share codewords with a known minimum distance from each other instead of the embeddings generated by each client device for their local data. Because the codewords are defined a priori with a known minimum distance, the client devices can each learn a local model using the positive loss term. In this example, the client devices can optimize a loss function defined according to the equation:

$$max {( 0 , 1 - \frac{1}{c} {v}_{y}^{T} σ ( W {g}_{θ} ( {x}_{i} ) ) )}^{2}$$

where c represents a scaling factor, v_{y} represents a selected codeword, and W represents a linear projection matrix. While embeddings need not be shared between client devices or otherwise exposed in this example, model similarity across client devices in the embedding spaces may exist due to the predefined codewords used to train the machine learning model.

In each of the examples discussed above, a machine learning model may be trained using federated learning. However, each of these examples compromise privacy for accuracy, or vice versa. The first and third examples may allow for the privacy of centroids to be preserved so that sensitive data cannot be derived therefrom; however, the accuracy of these models may be negatively impacted by an inability to maximize the distance between different centroids corresponding to different classes of data. The second example may allow for an accurate model to be trained; however, centroids or other sensitive data may still be shared outside of a client device, which may compromise the privacy and security of this sensitive data.

### Example Secure Centers and Secure Hyperspheres Used to Train Machine Learning Models

To allow for a machine learning model to be trained using local data without exposing the embeddings generated from the local data and while maintaining the accuracy of these models, aspects of the present disclosure train a global machine learning model by updating local models with a metric learning loss to minimize intra-class variance and maximize inter-class variance with respect to secure centers of secure hyperspheres generated by each of the client devices. By sharing information about a secure hypersphere, which generally includes a local hypersphere generated from embeddings for the data used by a client device to train a local machine learning model, the risk of exposing sensitive data may be reduced. That is, instead of sharing a central point from which information about the local data can be derived, aspects of the present disclosure allow for federated learning using a center point of a larger area that effectively obfuscates the local data used to train a local machine learning model while still allowing for intra-class variance to be minimized and allowing for inter-class variance to be maximized.

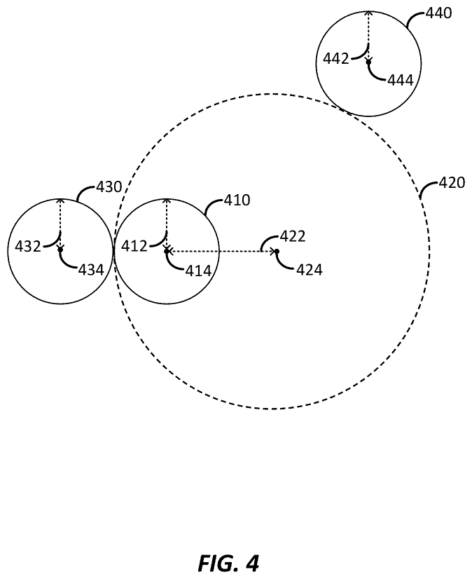

FIG. 4 illustrates an example of local and secure hyperspheres generated by client devices participating in training a machine learning model using federated learning, according to aspects of the present disclosure.

As illustrated, for a first client participating in training the machine learning model, a local hypersphere 410 may be generated with a radius 412 and a local center 414. To generate the secure hypersphere 420 for the first client, a distance 422 from the local center 414 for the first client may be selected. The distance 422, as discussed, is generally greater than the radius 412 of the local hypersphere. Generally, the secure center 424 may be defined as the sum of the local center and a value randomly sampled from a hypersphere having a radius of the distance 422 from the local center 414 for the first client.

In some aspects, a boundary of the local hypersphere 410 may coincide with a boundary of the secure hypersphere 420 (e.g., the local hypersphere 410 may be located at the edge of the secure hypersphere 420). If the secure center is selected as any other value other than the zeroed center point, the local hypersphere 410 may be located within the secure hypersphere 420 at a non-edge location. For example, if the secure center is selected as a point at the edge of the hypersphere having a radius of the distance 422 from the local center 414 for the first client, the local center 414 and the secure center 424 may coincide, and thus the local hypersphere 410 may be located in the center of the secure hypersphere 420.

In some aspects, the secure hypersphere 420 for the first client may thus be defined based on the secure center 424 and the sum of the radius 412 and the distance 422 from the local center 414. Generally, the ratio of the local hypersphere 410 for the first client and the secure hypersphere 420 for the first client may be represented according to the equation

$$\frac{{R}^{d}}{{( R + D )}^{d}}$$

where R corresponds to radius 412, D corresponds to the distance 422 from the local center 414, and d corresponds to a number of dimensions in the hypersphere. For a radius of 0.1, a distance from the local center of 0.1, and 128 dimensions, the likelihood of generating a sample included in a data set used to generate the local hypersphere 410, given a random vector, may thus be

$$\frac{0 . {1}^{128}}{{( 0.1 + 0.1 )}^{128}} = 2.9 * 1 {0}^{- 39}$$

Thus, for a highly dimensional hypersphere with an equal radius and distance from the local center, it is mathematically unlikely that a sample would be generated that corresponds to a sample in a data set used to generate the local hypersphere. Further reductions in the likelihood of generating a sample that corresponds to a sample in the data set used to generate the local hypersphere may be realized by increasing the dimensionality of an embedding vector.

Client devices associated with the local hypersphere 430 and the local hypersphere 440 may learn to locate these hyperspheres far from secure center 424 of secure hypersphere 420, as discussed in further detail below. Generally, in learning to locate hyperspheres 430 and 440, the client devices associated with these hyperspheres may learn based on maximizing a negative loss associated with inter-class variance so that these hyperspheres are distant from other hyperspheres associated with other client devices. The local hypersphere 430 and the local hypersphere 440 may be displaced from the secure center 424 of the secure hypersphere 420 by at least the radius of the secure hypersphere 420 (e.g., by at least the sum of radius 412 and distance 422).

In another example, a local hypersphere may be defined with a local center defined as a learnable parameter. For example, the local center may be associated with an embedding that is randomly initialized and learned jointly with the remainder of the global machine learning model being trained across multiple local devices. The local center may be learned by optimizing a positive loss function to minimize intra-class variation and optimizing a negative loss function to minimize inter-class variation, as discussed in further detail below.

A secure hypersphere may be defined as a hyperspherical cap, or a portion of a sphere cut by a plane. In such a case, the positive loss term, discussed in further detail below, may be optimized to locate embeddings g(x) for the local data on the surface of the hyperspherical. In locating the embeddings g(x) on the surface of the hypersphere, the embeddings g(x) may be normalized using various normalization techniques, such as L2 normalization in which a distance is calculated from an origin point on the hyperspherical cap (e.g., the local center of the hyperspherical cap). Meanwhile, the negative loss term, discussed in further detail below, may be optimized to locate embeddings g(x) for the local data outside of a different hyperspherical cap (e.g., a hyperspherical cap associated with data from another device used in training the global machine learning model).

The hyperspherical cap for the secure hypersphere may be generated with a secure center that is located outside of a hyperspherical cone for the local hypersphere defined by the local center and a local angle calculated for the local hypersphere. The hyperspherical cap may be defined as a spherical cap with the secure center c located outside of the local hyperspherical cap and a secure angle θ that is selected to enclose the local hyperspherical cap.

In some aspects, the center of a hypersphere may be defined based on a secure center w̅ₖ̅ that is an angle θ away from the true center of the hypersphere wₖ. In such a case, if a shared secure center is classified as a target class (e.g., the local center wₜ of a hypersphere overlaps with the secure center w̅ₖ̅ of a different hypersphere), a privacy leak may occur, and thus, the angle θ should be increased. However, if the angle θ is too large, information may be lost, and thus, Generally, the amount of privacy leakage may be measured according to the equation:

$$\frac{1}{M} {\sum }_{j} 1 ( arg {max}_{m} {\overline{w}}_{j}^{T} {w}_{m} = j )$$

where M, as discussed above, represents a number of nearest neighboring hyperspheres to a local hypersphere, w̅j̅^{T} represents the secure center of the j^{th} neighboring hypersphere, and wₘ represents the true center of the m^{th} hypersphere.

To minimize the amount of privacy leakage that may be caused by selecting a secure center that is different from a true center of a hypersphere, a loss function may be optimized to discriminate between information from a target participating device t and other participating devices k. This loss function may be defined according to the equation:

$$\frac{1}{N} {\sum }_{i} {( 1 - {g ( {x}_{i} )}^{T} {w}_{t} )}^{2} + λ \frac{1}{K - 1} {\sum }_{k \neq t} {( 1 + {w}_{t}^{T} \overline{{w}_{k}} )}^{2}$$

where g(xᵢ)^{T} represents an embedding of xᵢ, wₜ represents the true center of a hypersphere generated by participating device t, wₜ^{T} represents a learnable local center of the hypersphere generated by participating device t, and w̅ₖ̅ represents a secure center of a hypersphere generated by one of the other participating devices k.

In the example illustrated in FIG. 4, the radius of the secure hypersphere 420 is equal to the distance 422 from the local center 414 and the radius 412 of the local hypersphere 410. The secure center 424 may be generated based on a linear combination of the secure centers of neighboring hyperspheres generated by other participating devices in a federated learning scheme. For example, the secure center 424 may be defined according to the equation:

$$\overline{{w}_{t}} = α \cdot {w}_{t} + ( 1 - α ) \cdot \frac{1}{K} {\sum }_{k ∈ {𝒩}^{t o p - K} ( {w}_{t} )} \overline{{w}_{k}}$$

where w̅ₜ̅ represents the secure center 424, wₜ represents the local center 414, α represents a scaling factor, K represents a number of neighbors from which the secure center 424 is generated, and w̅ₖ̅ represents the secure center of the K^{th} neighbor hypersphere. Generally, the neighbors from which the secure center is created may be the K nearest neighbor hyperspheres to the local hypersphere 410. The values of α and K can control an amount of privacy leakage (e.g., leakage of information about the local data used by a participant device in a federated learning scheme to update a machine learning model) within the federated learning scheme. Generally, smaller values of α and larger values of K can reduce the amount of privacy leakage that may occur. In using smaller values of α, the local center 414 may have a smaller impact on the location of the secure center 424 than the shared secure centers 424 of the K neighboring hyperspheres. In using larger values of K, information from larger numbers of neighboring hyperspheres can be used to generate the secure center 424.

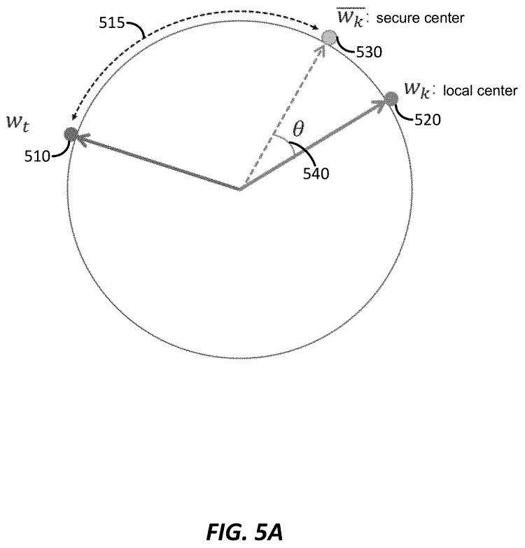

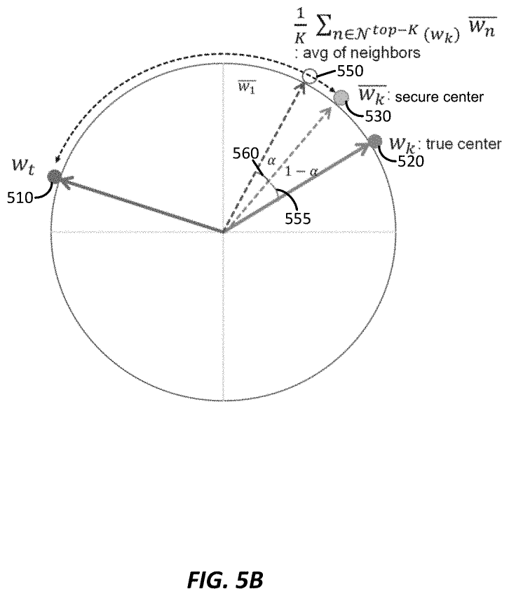

FIG. 5A illustrates an example of generating a secure center which may be used to optimize a loss function that discriminates between information from a target participating device t and other participating devices k. A secure center 530 of a hypersphere generated by a participating device k (not shown) may be defined relative to the local center 520 of the hypersphere generated by the participating device k (not shown) and an angle θ 540. As discussed, in order to avoid a privacy leak of the actual data used to generate the hypersphere by the participating device k, the angle θ 540 should be sufficiently large. Meanwhile, the center 510 of a target hypersphere (not shown) should be discriminated from the secure center 530 of the hypersphere generated by the participating device k (not shown) instead of the local center 520 so that information about the data used to generate a hypersphere by device k is not exposed to other participating devices in a federated learning scheme. Further, the distance 515 between the center 510 of the target hypersphere and the secure center 530 of the hypersphere generated by the participating device k (not shown) should be large enough such that the target hypersphere and the hypersphere generated by the participating device k (not shown) do not overlap.

FIG. 5B illustrates an example of generating a secure center which may be used to optimize a loss function that discriminates between information from a target participating device t and other participating devices k and an average of centers from a number of neighboring hyperspheres. As discussed, to generate the secure center 530, an angle α 560 and a number of neighbors K may be selected to control an amount of privacy leakage (e.g., leakage of information about the local data used by a participant device in a federated learning scheme to update a machine learning model) within the federated learning scheme. Angle α 560 generally represents a normalized angle, with a value between 0 and 1, that may be used as a weight in a linear combination of the local center 520 and the secure centers from the K neighbors. Based on angle α 560 and K, the average of the K neighbors may be calculated according to the equation:

$$\overline{{w}_{t}} = α \cdot {w}_{t} + ( 1 - α ) \cdot \frac{1}{K} {\sum }_{k ∈ {𝒩}^{t o p - K} ( {w}_{t} )} \overline{{w}_{k}}$$

as discussed above. An angle (1−α) 555, meanwhile, may separate the true center 520 from the secure center 530. In this example, the secure center may be generated by considering relationships between secure centers associated with neighboring hyperspheres generated by other client devices participating in the federated learning scheme.

As illustrated in FIGS. 5A and 5B, the secure center 530 is different from the true center 520. However, the secure center 530 generally includes sufficient information that allows for a machine learning model to be trained based on inter-class variance with respect to the secure centers generated by the participating devices in the federated learning scheme. Because the secure center 530 is different from the true center 520 but provides sufficient information for training a machine learning model, the secure center 530 may be considered a proxy for the true center 520.

### Example Methods for Training Machine Learning Models Using Secure Centers of Client Device Embeddings

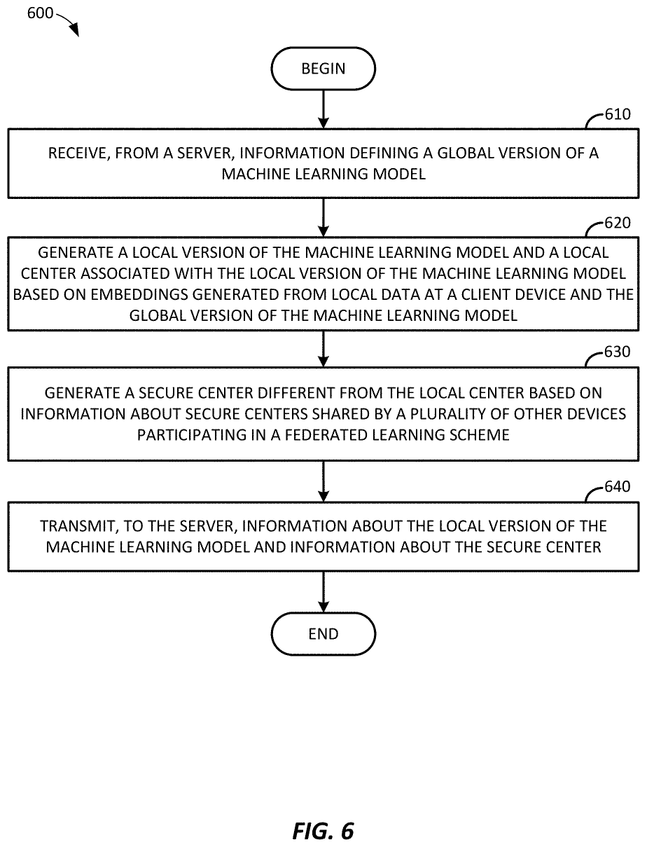

FIG. 6 illustrates example operations 600 that may be performed for training a machine learning model, according to certain aspects of the present disclosure. As used herein, training a machine learning model may include training a new machine learning model or modifying (e.g., updating) an extant machine learning model based on information about local models trained by a plurality of client devices participating in a federated learning procedure. Operations 600 may be performed, for example, by a client device participating in a federated learning procedure to train a global machine learning model using local models and information about local models trained by a plurality of other client devices participating in the federated learning procedure.

As illustrated, operations 600 begin at block 610, where information defining a global version of a machine learning model is received. Generally, the information defining the global version of the machine learning model may include a plurality of parameters defining the machine learning model, information about a plurality of secure centers (e.g., of secure hyperspheres) generated by other client devices, and information defining a radius of a secure hypersphere associated with each of the plurality of secure centers. The secure hypersphere associated with each of the plurality of secure centers may encompass the local hypersphere generated by the client device associated with the secure hypersphere. Because the secure hypersphere may be significantly larger than the local hypersphere, as discussed in further detail below, the likelihood that the data used by the client device associated with the secure hypersphere is exposed to other parties may be minimized.

At block 620, a local version of the machine learning model and a local center associated with the local version of the machine learning model is generated. In some aspects, generating the local version of the machine learning model may include generating a local hypersphere defined by a local center and a local measurement relative to the local center (e.g., a local radius, a local angle, etc.). The local center associated with the local version of the machine learning model may be generated based on embeddings generated from local data at a client device and the global version of the machine learning model.

In some aspects, to generate the local version of the global machine learning model, a local hypersphere may be generated. The local version of the machine learning model may be generated by optimizing a positive loss element associated with embeddings within the local hypersphere and a negative loss element associated with each of the plurality of secure centers with orthogonal regularization. The positive loss element generally corresponds to intra-class variation, and the negative loss element generally corresponds to inter-class variation.

Generally, the loss function to be optimized may include a positive loss element associated with embeddings within the local hypersphere and a negative loss element associated with each of the plurality of secure centers. The loss function may be represented by the equation:

l(θ,b)=lₚₒₛ(θ,b)+λ×l_{neg}(θ,b)

where θ represents the global machine learning model, b represents a batch of local data used to train or update the machine learning model, and Δ represents a regularization rate defined for the machine learning model to scale the influence of the negative loss component in optimizing the loss function.

As discussed, the positive loss function lₚₒₛ, is generally optimized to minimize intra-class variation. The positive loss function lₚₒₛ, may be represented by the equation:

$${l}_{p o s} ( θ , b ) = {\sum }_{i ∈ b} d ( {g}_{θ} ( {x}_{i} ) , {C}^{k} )$$

where d represents a distance calculated between an embedding g_{θ} for a value x in the batch of local data b, and C^{k} represents the center of the local hypersphere.

The negative loss function, which may be optimized to maximize inter-class variation, may be defined according to the equation:

$${l}_{n e g} ( θ , b ) = {\sum }_{i ∈ b} {\sum }_{j \neq k} max ( ( {R}^{j} + {D}^{j} ) - d ( {g}_{θ} ( {x}_{i} ) , {A}^{j} ) , 0 )$$

where (R^{j}+D^{j}) represents the radius of a secure hypersphere for the j^{th} client device and d(g_{θ}(xᵢ), A^{j}) represents the distance between an embedding g_{θ} for a value x in the batch of local data b and the center of the secure hypersphere A^{j}. Generally, (R^{j}+D^{j}) may be the margin for the negative loss, and there may be no loss when an embedding vector is located outside of a secure hypersphere for the j^{th} client.

In some aspects, the local center (e.g., within the local hypersphere) may be calculated as an average over embeddings generated from the local data. In some aspects, the local center (e.g., within the local hypersphere) may be calculated as a moving average of embedding vectors used in calculating a loss function for the local hypersphere.

In some aspects, the local center may be a learnable parameter that is jointly optimized with the global machine learning model. The local center may, for example, be randomly initialized and learned over time.

In some aspects, where a local hypersphere is generated with a local measurement relative to the local center, the local measurement relative to the local center may be a local radius of the local hypersphere. The local radius of the local hypersphere may be calculated based on the calculated local center of the local hypersphere. The local radius may be calculated by identifying a maximum distance between the local center of the local hypersphere and each of the embeddings generated from local data at the client device and the global machine learning model.

In some aspects, the local measurement relative to the local center may be a local angle for the local hypersphere, measured from an axis passing through the local center.

For a local hypersphere defined by a local center and a local angle, a loss function to be optimized may include a positive loss function associated with embeddings on a surface of the local hypersphere and a negative loss element associated with each of a plurality of secure centers. The loss function may be represented by the equation:

l([θ,C^{k}],b)=lₚₒₛ([θ,C^{k}],b)+λ×l_{neg}(θ,b)

where θ represents the global machine learning model, C^{k} represents the local center, b represents a batch of local data used to train or update the machine learning model, and λ represents a regularization rate defined for the machine learning model to scale the influence of the negative loss component in optimizing the loss function.

The positive loss function, lₚₒₛ([θ, C^{k}], b), is generally optimized to minimize intra-class variation such that embeddings for batch b of local data are generally located on a surface of the local hypersphere (or a cap of the local hypersphere). The positive loss function, lₚₒₛ, may be represented by the equation:

$${l}_{p o s} ( [ θ , {C}^{k} ] , b ) = {\sum }_{i ∈ b} d ( {g}_{θ} ( {x}_{i} ) , {C}^{k} ) )$$

where d represents a negative cosine between two vectors x and y, and C^{k} represents the center of the local hypersphere.

The negative loss function, l_{neg}(θ, b), may be optimized to maximize inter-class variation so that data not included in or similar to the data in the batch of local data b is located outside of the local hypersphere (e.g., not located on the surface of the local hypersphere or within the local hypersphere). In some aspects, the negative loss function, I_{neg}, may be defined according to the equation:

$${l}_{n e g} ( θ , b ) = {\sum }_{i ∈ b} {\sum }_{j \neq k} max ( {M}^{j} - d ( {g}_{θ} ( {x}_{i} ) , {A}^{j} ) , 0 )$$

where M^{j}=(R^{j}+D^{j}) represents the radius of a secure hypersphere for the j^{th} client device and d(g_{θ}(xᵢ), A^{j}) represents a negative cosine between an embedding g_{θ} for a value x in the batch of local data b (which, as discussed above, may be located on a surface of a local hypersphere) and the center of the secure hypersphere A^{j}. Generally, (R^{j}+D^{j}) may be the margin for the negative loss, and there may be no loss when an embedding vector is located outside of a secure hypersphere for the j^{th} client.

A resulting local angle R^{k} may be the maximum angle between an embedding g_{θ}(x) and the local center C^{k}.

In some aspects, when using cosine similarity in the negative loss function I_{neg}, there may be a negative correlation between different embedding values go. To avoid this negative correlation between class embeddings, orthogonal regularization may be jointly minimized with the negative loss. This orthogonal regularization may be defined according to the equation:

$${\sum }_{k \neq t} {( 1 + \vert {w}_{r}^{T} \overline{{w}_{k}} \vert )}^{2}$$

where wₜ^{T} represents the local center of the hypersphere, which may be a learnable class embedding, and w̅ₖ̅ represents the secure centers of hyperspheres generated by other participating devices in a federated learning scheme. In another example, this orthogonal regularization may be defined according to the equation:

$${\sum }_{k \neq t} {( 1 + \vert {{g}_{θ} ( x )}_{t}^{T} \overline{{w}_{k}} \vert )}^{2}$$

where g_{θ}(x)ₜ^{T} represents an instance embedding, and w̅ₖ̅ represents the secure centers of hyperspheres generated by other participating devices in a federated learning scheme. In each of these equations, the centers or embeddings may be L2 normalized.

At block 630, a secure center is generated. The secure center, such as secure center 530 illustrated in FIGS. 5A and 5B and described above, is generally defined by the local center associated with the local version of the machine learning model (e.g., the local center of the local hypersphere), secure centers shared by a plurality of other devices participating in a federated learning scheme, and a scaling factor.

In some aspects, the measurement relative to the local center may include a distance from the local center. The distance from the local center selected to define the secure hypersphere may generally be a distance greater than the local radius of the local hypersphere. By selecting a distance greater than the local radius of the local hypersphere, aspects of the present disclosure may maximize the size of the secure hypersphere and thus minimize the risk that the secure center can be used to compromise the privacy and security of the local data from which the local hypersphere was generated. In some aspects, the secure center may be defined as a sum of a scaled value of the local center and scaled average of secure centers shared by a plurality of other devices participating in a federated learning scheme. By selecting the secure center as a random value between the local radius and the distance from the local center, the secure hypersphere may be defined such that the local hypersphere is located in some random region within the secure hypersphere. Because the location of the local hypersphere within the secure hypersphere may not be predictably determined, aspects of the present disclosure may thus further complicate the process of attempting to extract embeddings in the local hypersphere or the underlying local data from which the local hypersphere was generated. Thus, the privacy and security of the underlying local data from which the local hypersphere was generated may be preserved.

In some aspects, the secure center may be selected based on a uniformly random selection of points A^{k} with an angle D^{k} defined according to the equation: D^{k}=∠(A^{k}, C^{k})≥R^{k}. The selected angle D^{k} may be an angle between a randomly selected point A^{k} and a local center C^{k} that exceeds the local angle R^{k} discussed above. By selecting an angle D^{k} that exceeds the local angle R^{k}, the local hyperspherical cap on which local data resides may be encompassed by a secure hyperspherical cap which may be used in the global machine learning model. Because the local hyperspherical cap may be a portion of the secure hyperspherical cap, and because devices using the global machine learning model may not be able to identify which portions of the secure hyperspherical cap correspond to the local hyperspherical cap, the secure hypersphere may allow for data to be accurately classified while maintaining the privacy of data used to generate the local hyperspherical cap and secure hyperspherical cap.

At block 640, information about the local version of the global machine learning model and information about the secure center is transmitted to the server. In some aspects, the information about the secure center includes a value of the secure center and a radius of a secure hypersphere defined by the secure center. The radius of the secure hypersphere may be defined as a sum of the calculated local radius of the local hypersphere and the distance from the local center, as discussed above.

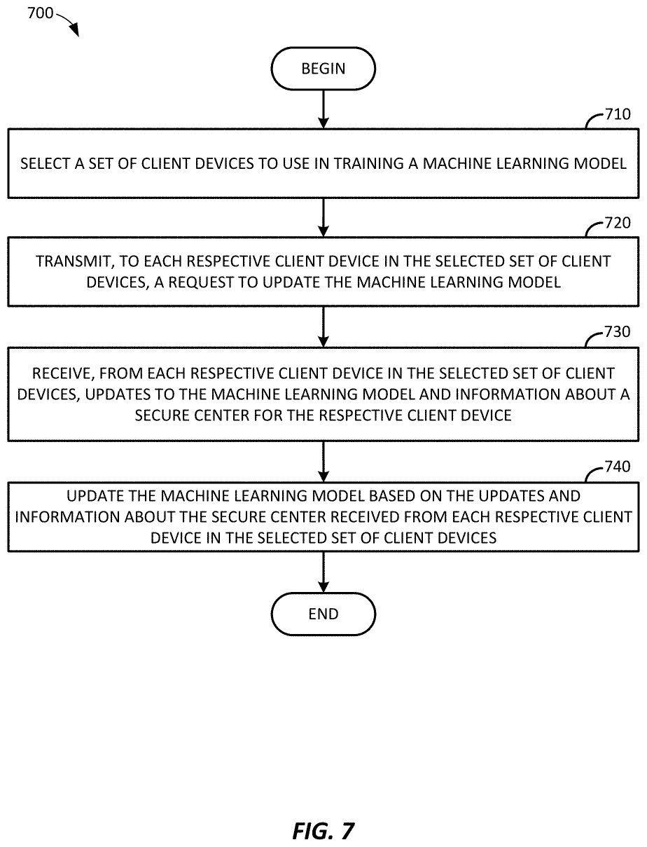

FIG. 7 illustrates example operations 700 that may be performed by a server to distribute training of a machine learning model across client devices, according to certain aspects described herein.

As illustrated, operations 700 begin at block 710, where a set of client devices to use in training a machine learning model are selected. In some aspects, the set of client devices may be selected based on a proximity of a secure hypersphere associated with each client device in the set of client devices to one or more secure hyperspheres associated with client devices that have previously participated in training the machine learning model. Each secure hypersphere of the one or more secure hyperspheres is generally defined by a secure center point and a secure radius, as discussed above.

In some aspects, the set of client devices to be used in training the machine learning model may be selected based on one or more criteria. For example, client devices with higher usage and data acquisition may be selected over client devices with lower usage and data acquisition, as these devices may provide additional data that can be used to improve the quality of the machine learning model. In some aspects, client devices may be selected based on an amount of time elapsed since the client devices last participated in training or updating the machine learning model. Client devices that have participated in training or updating the machine learning model in the distant past may be selected over client devices that have more recently participated in training or updating the machine learning model, as the client devices that have participated in training or updating the machine learning model in the distant past may be assumed to have additional (and potentially newer) data that can be used to train and/or update the machine learning model.

At block 720, a request to update the machine learning model is transmitted to each respective client device in the selected set of client devices. The request generally includes information defining the machine learning model. This information may include a plurality of model parameters and a plurality of secure centers associated with other participating devices in a federated learning scheme. In some aspects, the information may include information defining a radius of a secure hypersphere associated with each of the plurality of secure centers. As discussed above, by sharing the plurality of secure centers and the radii or angles of the secure hyperspheres associated with the plurality of secure centers, the client devices that receive the request to update the global machine learning model may learn to generate embeddings that are far away from each of the plurality of secure centers (e.g., by optimizing a negative loss function in which the difference between the radius of the secure hypersphere and the distance between an embedding the a secure center is a factor and a positive loss function in which differences between a local center and embeddings generated from local data are a factor).

At block 730, updates to the machine learning model and information about a secure center for each of the respective client devices in the selected set of client devices are received. The updates to the machine learning model may include, for example, parameters defining a local version of the machine learning model generated by each of the respective client devices in the selected set of client devices. The information about the secure center of the secure hypersphere may include a value of the secure center and a measurement for the secure hypersphere relative to the secure center of the secure hypersphere. The measurement may be a radius, or distance from the secure center of the secure hypersphere, or an angle relative to an axis passing through the secure center of the secure hypersphere.

At block 740, the machine learning model is updated based on the updates and information about the secure center received from each respective client device in the selected set of client devices. In some aspects, the update to the global machine learning model may be determined by generating an average value over the parameters of the global machine learning model and the updates received from each respective client device in the selected set of client devices.

### Example Processing Systems for Training Machine Learning Models Using Secure Centers of Client Device Embeddings

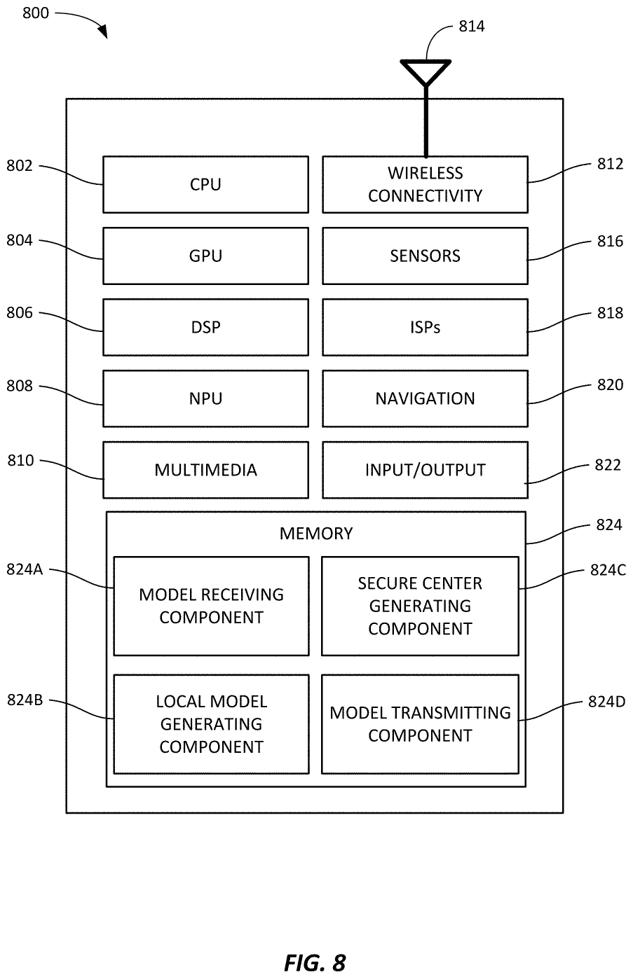

FIG. 8 depicts an example processing system 800 for training a machine learning model, such as described herein for example with respect to FIG. 6.

Processing system 1200 includes a central processing unit (CPU) 802, which in some examples may be a multi-core CPU. Instructions executed at the CPU 802 may be loaded, for example, from a program memory associated with the CPU 802 or may be loaded from a memory partition 824.

Processing system 800 also includes additional processing components tailored to specific functions, such as a graphics processing unit (GPU) 804, a digital signal processor (DSP) 806, a neural processing unit (NPU) 808, a multimedia processing unit 810, a wireless connectivity component 812.

An NPU, such as 808, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 812 is further connected to one or more antennas 814.

Processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes model receiving component 824A, local model generating component 824B, secure center generating component 824C, and model transmitting component 824D. The depicted components, and others not depicted, may be configured to perform various aspects of the methods described herein.

Generally, processing system 800 and/or components thereof may be configured to perform the methods described herein.

Notably, in other embodiments, aspects of processing system 800 may be omitted, such as where processing system 800 is a server computer or the like. For example, multimedia component 810, wireless connectivity 812, sensors 816, ISPs 818, and/or navigation component 820 may be omitted in other embodiments. Further, aspects of processing system 800 may be distributed, such as training a model and using the model to generate inferences.

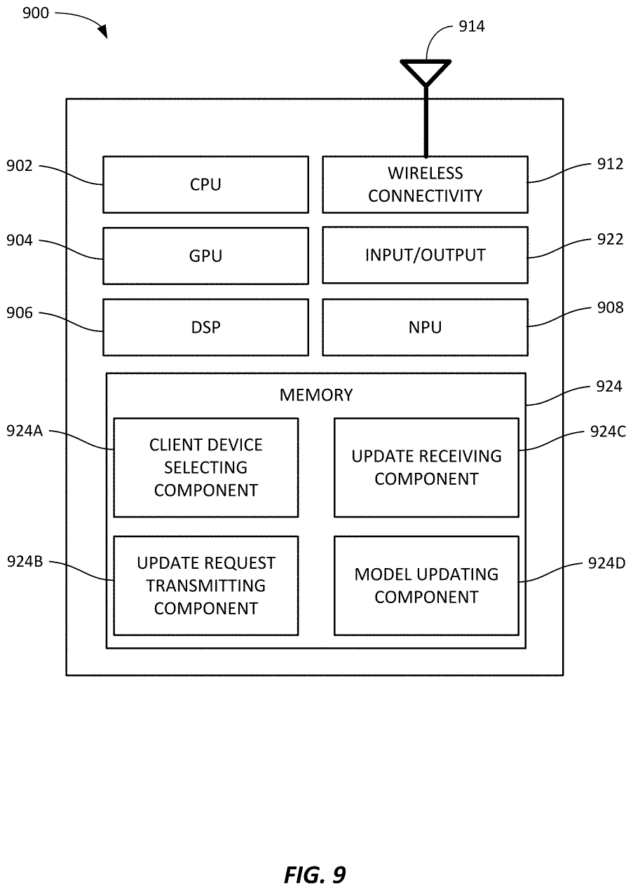

FIG. 9 depicts an example processing system 900 for distributing training of a machine learning model across client devices, such as described herein for example with respect to FIG. 7.

Processing system 900 includes a central processing unit (CPU) 902, which in some examples may be a multi-core CPU. Instructions executed at the CPU 902 may be loaded, for example, from a program memory associated with the CPU 902 or may be loaded from a memory partition 924.

Processing system 900 also includes additional processing components tailored to specific functions, such as a graphics processing unit (GPU) 904, a digital signal processor (DSP) 906, a neural processing unit (NPU) 908, and a wireless connectivity component 912.

An NPU, such as 908, may be as described above with respect to FIG. 8. In one implementation, NPU 908 is a part of one or more of CPU 902, GPU 904, and/or DSP 906.

In some examples, wireless connectivity component 912 may be as described above with respect to FIG. 8.

Processing system 900 may also include one or more input and/or output devices 922, such as screens, touch-sensitive surfaces (including touch-sensitive displays), physical buttons, speakers, microphones, and the like.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes client device selecting component 924A, update request transmitting component 924B, update receiving component 924C, and model updating component 924D. The depicted components, and others not depicted, may be configured to perform various aspects of the methods described herein.

Generally, processing system 900 and/or components thereof may be configured to perform the methods described herein.

Aspects of processing system 900 may be distributed, such as training a model and using the model to generate inferences.

### Example Clauses

Implementation details of various aspects of the present disclosure are described in the following numbered clauses.

Clause 1: A method for modifying a machine learning model, comprising: receiving, at a local device from a server, information defining a current version of a global machine learning model; generating a local version of the global machine learning model, a local hypersphere defined by a local center and a local radius based on embeddings generated from local data at a client device and the current version of the global machine learning model; generating a secure hypersphere defined by a secure center, the local radius of the local hypersphere, a distance from the local center, and a proximity to a plurality of hyperspheres in the global machine learning model; and transmitting, to the server, information about the local version of the global machine learning model and information about the secure hypersphere.

Clause 2: The method of Clause 1, wherein the information defining the current version of the global machine learning model comprises a plurality of hyperparameters, a plurality of secure centers, and information defining a radius of a secure hypersphere associated with each of the plurality of secure centers.

Clause 3: The method of Clause 2, wherein generating the local hypersphere comprises: minimizing a positive loss function for embeddings within the local hypersphere; and maximizing a negative loss function relative to each secure center of the plurality of secure centers with orthogonal regularization.

Clause 4: The method of any one of Clauses 1 through 3, wherein calculating the local center within the local hypersphere comprises calculating an average over the embeddings generated from the local data at the client device and the global machine learning model.

Clause 5: The method of any one of Clauses 1 through 3, wherein calculating the local center within the local hypersphere comprises calculating a moving average of embedding vectors used in calculating a loss function for the local hypersphere.

Clause 6: The method of any one of Clauses 1 through 5, further comprising calculating the local radius of the local hypersphere by identifying a maximum distance between the local center and each of the embeddings generated from local data at the client device and the global machine learning model.

Clause 7: The method of any one of Clauses 1 through 6, wherein the distance from the local center comprises a distance greater than the local radius of the local hypersphere such that the local hypersphere is contained within the secure hypersphere.

Clause 8: The method of Clause 7, wherein the secure center is defined as a sum of the local center and a value randomly sampled from a hypersphere having a radius of the distance from the local center and a zeroed center point.

Clause 9: The method of any one of Clauses 1 through 8, wherein the secure center is defined as a sum of a scaled value of the local center and scaled average of secure centers shared by a plurality of other devices participating in a federated learning scheme.

Clause 10: A method for distributing training of a machine learning model across client devices, comprising: selecting a set of client devices to use in training a global machine learning model based on a proximity of a hypersphere associated with each client device in the set of client devices to one or more secure hyperspheres, each secure hypersphere being defined by a secure center point and a secure radius; transmitting, to each respective client device in the selected set of client devices, a request to update the global machine learning model; receiving, from each respective client device in the selected set of client devices, updates to the global machine learning model and information about a secure center of a secure hypersphere for the respective client device; and updating the global machine learning model based on the updates and information about the secure center received from each respective client device in the selected set of client devices.

Clause 11: The method of Clause 10, wherein the request to update the global machine learning model includes information defining the global machine learning model.

Clause 12: The method of Clause 11, wherein the information defining the global machine learning model comprises a plurality of hyperparameters, a plurality of secure centers, and information defining a radius of a secure hypersphere associated with each of the plurality of secure centers.

Clause 13: The method of any one of Clauses 10 through 12, wherein the updates to the global machine learning model and information about the secure center of the secure hypersphere for the respective client device comprise an updated model, a value of the secure center of the secure hypersphere for the respective client device, and a radius of the secure hypersphere from the secure center of the secure hypersphere.

Clause 14: The method of any one of Clauses 10 through 13, wherein updating the global machine learning model comprises generating an average over the global machine learning model and the updates received from each respective client device in the selected set of client devices.

Clause 15: An apparatus, comprising: a memory having executable instructions stored thereon; and a processor configured to execute the executable instructions to cause the apparatus to perform a method in accordance with of any one of Clauses 1 through 14.

Clause 16: An apparatus, comprising: means for performing a method in accordance with of any one of Clauses 1 through 14.

Clause 17: A non-transitory computer-readable medium having instructions stored thereon which, when executed by a processor, performs a method in accordance with of any one of Clauses 1 through 14.

Clause 18: A computer program product embodied on a computer-readable storage medium comprising code for performing a method in accordance with of any one of Clauses 1 through 14.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for training a machine learning model, comprising:
receiving, at a local device from a server, information defining a global version of a machine learning model;
generating, by the local device, a local version of the machine learning model and a local center associated with the local version of the machine learning model based on embeddings generated from local data at a client device and the global version of the machine learning model;
generating, by the local device, a secure center different from the local center based, at least in part, on information about secure centers shared by a plurality of other devices participating in a federated learning scheme; and
transmitting, by the local device to the server, information about the local version of the machine learning model and information about the secure center.

2. The method of claim 1, wherein the information defining the global version of the machine learning model comprises a plurality of hyperparameters, a plurality of secure centers, and information defining a radius of a secure hypersphere associated with each of the plurality of secure centers or an angle measured relative to an axis passing through each of the plurality of secure centers.

3. The method of claim 2, wherein generating the local version of the machine learning model comprises generating a local hypersphere defined by the local center and a local measurement relative to the local center by:
minimizing a positive loss function for embeddings within the local hypersphere; and
maximizing a negative loss function relative to each secure center of the plurality of secure centers with orthogonal regularization.

4. The method of claim 3, wherein:
the local measurement relative to the local center comprises a local radius of the local hypersphere, and
the method further comprises calculating the local radius of the local hypersphere by identifying a maximum distance between the local center and each of the embeddings generated from local data at the client device and the global version of the machine learning model.

5. The method of claim 3, wherein:
generating the secure center comprises generating a secure hypersphere defined by the secure center, the local center of the local hypersphere, a measurement relative to the local center, and a proximity to a plurality of hyperspheres in the global version of the machine learning model,
the measurement relative to the local center comprises a distance from the local center, and
the distance from the local center comprises a distance greater than a local radius of the local hypersphere such that the local hypersphere is contained within the secure hypersphere.

6. The method of claim 1, wherein calculating the local center comprises calculating an average over the embeddings generated from the local data at the client device and the global version of the machine learning model.

7. The method of claim 1, wherein calculating the local center comprises calculating a moving average of embedding vectors used in calculating a loss function for a local hypersphere defined by the local center.

8. The method of claim 1, wherein calculating the local center comprises updating the local center from a randomly initialized initial position.

9. The method of claim 1, wherein the secure center is defined as a sum of a scaled value of the local center and scaled average of secure centers shared by one or more devices of the plurality of other devices participating in the federated learning scheme.

10. The method of claim 9, wherein the scaled average of the secure centers shared by the one or more devices of the plurality of other devices participating in the federated learning scheme is scaled based on a scaling factor associated with a weight assigned to the local center.

11. The method of claim 9, wherein the secure centers shared by the one or more devices of the plurality of other devices participating in the federated learning scheme comprises secure centers associated with a number of hyperspheres closest to a local hypersphere defined by the local center.

12. The method of claim 1, wherein generating the local version of the machine learning model comprises optimizing a loss function including a positive loss function associated with embeddings on a surface of a local hypersphere defined by the local center and a negative loss function associated with each secure center of a plurality of secure centers.

13. The method of claim 12, wherein optimizing the loss function comprises optimizing the positive loss function to minimize intra-class variation for a batch of local data such that embeddings for the batch of local data is located on a surface of a local hypersphere.

14. The method of claim 12, wherein optimizing the loss function comprises optimizing the negative loss function to maximize inter-class variation such that data different from a batch of local data is located away from a surface of a local hypersphere.

15. The method of claim 1, wherein the information about the secure center comprises a value of the secure center and a sum of a local radius of a local hypersphere defined by the local center and a measurement from the local center.

16. The method of claim 1, wherein the information about the secure center comprises a value of the secure center and an angle relative to an axis passing through the secure center exceeding an angle associated with a local hypersphere defined by the local center.

17. The method of claim 1, wherein the secure center comprises a proxy for the local center such that sharing the secure center minimizes exposure of the local data at the client device.

18. A method for distributed training of a machine learning model across client devices, comprising:
selecting a set of client devices to use in training a machine learning model;
transmitting, to each respective client device in the selected set of client devices, a request to update the machine learning model;
receiving, from each respective client device in the selected set of client devices, updates to the machine learning model and information about a secure center for the respective client device; and
updating the machine learning model based on the updates and information about the secure center received from each respective client device in the selected set of client devices.

19. The method of claim 18, wherein the request to update the machine learning model includes information defining the machine learning model.

20. The method of claim 19, wherein the information defining the machine learning model comprises a plurality of hyperparameters, a plurality of secure centers associated with devices participating in a federated learning scheme, and one or more measurements associated with each secure center of the plurality of secure centers.

21. The method of claim 20, wherein the one or more measurements comprise information defining a radius of a secure hypersphere associated with each secure center of the plurality of secure centers or an angle relative to an axis passing through each secure center of the plurality of secure centers.

22. The method of claim 18, wherein the updates to the machine learning model and information about the secure center for the respective client device comprise an updated model, a value of the secure center of a secure hypersphere for the respective client device defined by the secure center, and a radius of the secure hypersphere or an angle relative to an axis passing through the secure center.

23. The method of claim 18, wherein updating the machine learning model comprises generating an average over the machine learning model and the updates received from each respective client device in the selected set of client devices.

24. A processing system, comprising:
a memory comprising computer-executable instructions; and
one or more processors configured to execute the computer-executable instructions and cause the processing system to:
receive, at a local device from a server, information defining a global version of a machine learning model;
generate, by the local device, a local version of the machine learning model and a local center associated with the local version of the machine learning model based on embeddings generated from local data at a client device and the global version of the machine learning model;
generating, by the local device, a secure center different from the local center based on information about secure centers shared by a plurality of other devices participating in a federated learning scheme; and
transmit, by the local device to the server, information about the local version of the machine learning model and information about the secure center.

25. The processing system of claim 24, wherein the secure center is defined as a sum of a scaled value of the local center and scaled average of secure centers shared by one or more devices of the plurality of other devices participating in the federated learning scheme.

26. The processing system of claim 25, wherein the scaled average of the secure centers shared by the one or more devices of the plurality of other devices participating in the federated learning scheme is scaled based on a scaling factor associated with a weight assigned to the local center.

27. The processing system of claim 24, wherein in order to generate the local version of the machine learning model, the processor is configured to cause the processing system to optimize a loss function including a positive loss function associated with embeddings on a surface of a local hypersphere defined by the local center and a negative loss function associated with each secure center of a plurality of secure centers.

28. The processing system of claim 27, wherein in order to optimize the loss function, the processor is configured to cause the processing system to optimize the positive loss function to minimize intra-class variation for a batch of local data such that embeddings for the batch of local data is located on a surface of a local hypersphere.

29. The processing system of claim 27, wherein in order to optimize the loss function, the processor is configured to cause the processing system to optimize the negative loss function to maximize inter-class variation such that data different from a batch of local data is located away from a surface of a local hypersphere.

30. A processing system, comprising:
a memory comprising computer-executable instructions; and
one or more processors configured to execute the computer-executable instructions and cause the processing system to:
select a set of client devices to use in training a machine learning model;
transmit, to each respective client device in the selected set of client devices, a request to update the machine learning model;
receive, from each respective client device in the selected set of client devices, updates to the machine learning model and information about a secure center for the respective client device; and
update the machine learning model based on the updates and information about the secure center received from each respective client device in the selected set of client devices.
